(19) United States
(12) Patent Application Publication
(10) Pub. No.: US 2026/0222305 A1
(43) Pub. Date: Jul. 30, 2026

(54) COMMUNICATION METHOD, COMMUNICATION APPARATUS AND COMMUNICATION DEVICE

(71) Applicant: Beijing Xiaomi Mobile Software Co., Ltd., Beijing (CN)

(72) Inventor: Min LIU, Beijing (CN)

(73) Assignee: Beijing Xiaomi Mobile Software Co., Ltd., Beijing (CN)

(21) Appl. No.: 19/145,443

(22) PCT Filed: Jan. 3, 2023
(86) PCT No.: PCT/CN2023/070242

§ 371 Date: Jul. 2, 2025

(51) Int. Cl. H04L 41/14; H04W 8/24

(52) U.S. Cl. CPC H04L 41/145; H04W 8/24

(57) ABSTRACT

The embodiments of the present disclosure provide a model-based communication method, a communication apparatus and a communication device. The method may comprise: indicating model information of a first model to a second communication device, wherein the first model is a model used by a side encoder and/or decoder of a first communication device, or a model that the first communication device recommends the second communication device to use.

### CROSS REFERENCE TO RELATED APPLICATION

This application is a National Stage of International Application No. PCT/CN2023/070242, filed on Jan. 3, 2023, which is incorporated by reference herein in its entirety for all purposes.

### TECHNICAL FIELD

The present disclosure relates to the technical field of wireless communication, in particular to a communication method, a communication apparatus, and a communication device.

### BACKGROUND

Deep learning is an artificial intelligence (AI) technology that automatically extracts the intrinsic features and patterns of data by constructing deep networks. In recent years, many researchers in the field of communication have applied deep learning technology to communication-related fields. Compared with traditional communication algorithms, deep learning has achieved better performance in areas such as channel estimation, signal detection, and channel state information (CSI) feedback.

### SUMMARY

The present disclosure provides a communication method, a communication apparatus, and a communication device.

According to a first aspect of the present disclosure, a communication method is provided. The communication method can be applied to a first communication device in a communication system. The method may include: indicating model information of a first model to a second communication device, where the first model is a trainable model used by an encoder and/or a decoder on a side of the first communication device, or a trainable model suggested by the first communication device to be used by an encoder or a decoder on a side of the second communication device.

In some possible implementations, the model information of the first model includes at least one of the following: a backbone network of the first model, a network structure of the first model, a hyperparameter of the first model, and a model parameter of the first model.

In some possible implementations, indicating the model information of the first model to the second communication device includes: sending first indication information to the second communication device, where the first indication information is used for indicating the model information of the first model.

In some possible implementations, indicating the model information of the first model to the second communication device includes sending the model information of the first model to the second communication device.

In some possible implementations, before indicating the model information of the first model to the second communication device, the method further includes receiving a first message sent by the second communication device, where the first message is used for requesting the model information of the first model from the first communication device.

In some possible implementations, the first communication device is a network device, and the second communication device is a terminal device; before indicating the model information of the first model to the second communication device, the method further includes: receiving first capability information sent by the second communication device, where the first capability information is at least used for indicating an artificial intelligence (AI) capability of the second communication device; indicating the model information of the first model to the second communication device includes: indicating the model information of the first model to the second communication device based on the first capability information.

In some possible implementations, the first communication device is a terminal device, and the second communication device is a network device; before indicating the model information of the first model to the second communication device, the method further includes: receiving training configuration information sent by the second communication device; indicating the model information of the first model to the second communication device includes: indicating the model information of the first model to the second communication device based on the training configuration information.

According to a second aspect of the present disclosure, a communication method is provided. The communication method can be applied to a second communication device in a communication system. The method may include: obtaining model information of a first model indicated by a first communication device, where the first model is a trainable model used by an encoder and/or a decoder on a side of the first communication device, or a trainable model suggested by the first communication device to be used by an encoder or a decoder on a side of the second communication device; and training the encoder or the decoder on the side of the second communication device based on the model information of the first model.

In some possible implementations, the model information of the first model includes at least one of the following: a backbone network of the first model; a network structure of the first model; a hyperparameter of the first model; and a model parameter of the first model.

In some possible implementations, obtaining the model information of the first model indicated by the first communication device includes: receiving first indication information sent by the first communication device, where the first indication information is used for indicating the model information of the first model.

In some possible implementations, obtaining the model information of the first model indicated by the first communication device includes receiving the model information of the first model sent by the first communication device.

In some possible implementations, before obtaining the model information of the first model indicated by the first communication device, the above method further includes: sending a first message to the first communication device, where the first message is used for requesting the model information of the first model from the first communication device; obtaining the model information of the first model indicated by the first communication device includes: obtaining the model information of the first model indicated, in response to the first message, by the first communication device.

In some possible implementations, the first communication device is a network device and the second communication device is a terminal device; before obtaining the model information of the first model indicated by the first communication device, the above method further includes: sending first capability information to the first communication device, where the first capability information is at least used for indicating an AI capability of the second communication device; obtaining the model information of the first model indicated by the first communication device comprises: obtaining the model information of the first model indicated, in response to the first capability information, by the first communication device.

In some possible implementations, the first communication device is a terminal device, and the second communication device is a network device; the above method further includes: sending training configuration information to the first communication device; obtaining the model information of the first model indicated by the first communication device includes: obtaining the model information of the first model indicated, in response to the training configuration information, by the first communication device.

According to a third aspect of the present disclosure, a communication apparatus is provided. The communication apparatus may be a first communication device in a communication system, a chip or system-on-chip in the first communication device, or a functional module in the first communication device, being used for implementing the method according to the various embodiments. The communication apparatus can implement the functions executed by the first communication device according to the various embodiments, and these functions can be implemented through the execution of corresponding software by hardware. The hardware or software includes one or multiple modules corresponding to the above functions. The communication apparatus includes: a transmission module, being used for indicating model information of a first model to a second communication device, where the first model is a trainable model used by an encoder and/or a decoder on a side of the first communication device, or a trainable model suggested by the first communication device to be used by an encoder or a decoder on a side of the second communication device.

In some possible implementations, the model information of the first model includes at least one of the following: the backbone network of the first model; the network structure of the first model; the hyperparameter of the first model; and the model parameter of the first model.

In some possible implementations, the transmission module is used for sending first indication information to the second communication device, where the first indication information is used for indicating the model information of the first model.

In some possible implementations, the transmission module is used for sending the model information of the first model to the second communication device.

In some possible implementations, the transmission module is further used for receiving a first message sent by the second communication device before indicating the model information of the first model to the second communication device, where the first message is used for requesting the model information of the first model from the first communication device.

In some possible implementations, the first communication device is a network device, and the second communication device is a terminal device; the transmission module is used for: receiving first capability information sent by the second communication device, where the first capability information is at least used for indicating an AI capability of the second communication device; and indicating the model information of the first model to the second communication device based on the first capability information.

In some possible implementations, the first communication device is a terminal device, and the second communication device is a network device; the transmission module is used for: receiving training configuration information sent by the second communication device; and indicating the model information of the first model to the second communication device based on the training configuration information.

According to a fourth aspect of the present disclosure, a communication apparatus is provided. The communication apparatus may be a second communication device in a communication system, a chip or system-on-chip in the second communication device, or a functional module in the second communication device, being used for implementing the methods according to the various embodiments. The communication apparatus can implement the functions executed by the second communication device according to the above various embodiments, and these functions can be implemented through the execution of corresponding software by hardware. The hardware or software includes one or multiple modules corresponding to the above functions. The communication apparatus includes: a transmission module, being used for obtaining the model information of a first model indicated by a first communication device, where the first model is a trainable model used by an encoder and/or a decoder on a side of the first communication device, or a trainable model suggested by the first communication device to be used by an encoder or a decoder on a side of the second communication device; and a processing module, being used for training the encoder or the decoder on the side of the second communication device based on the model information of the first model.

In some possible implementations, the model information of the first model includes at least one of the followings: the backbone network of the first model; the network structure of the first model; the hyperparameter of the first model; and the model parameter of the first model.

In some possible implementations, the transmission module is used for receiving first indication information sent by the first communication device, where the first indication information is used for indicating the model information of the first model.

In some possible implementations, the transmission module is used for receiving the model information of the first model sent by the first communication device.

In some possible implementations, the transmission module is further used for sending a first message to the first communication device, where the first message is used for requesting model information of the first model from the first communication device; and obtaining the model information of the first model indicated, in response to the first message, by the first communication device.

In some possible implementations, the first communication device is a network device, and the second communication device is a terminal device; the transmission module is further used for sending first capability information to the first communication device, where the first capability information is at least used for indicating an AI capability of the second communication device; and obtaining the model information of the first model indicated, in response to the first capability information, by the first communication device.

In some possible implementations, the first communication device is a terminal device, and the second communication device is a network device; the transmission module is further used for sending training configuration information to the first communication device; and obtaining the model information of the first model indicated, in response to the training configuration information, by the first communication device.

According to a fifth aspect of the present disclosure, a communication device, such as a first communication device, is provided. The communication device includes: an antenna; a memory; and a processor, respectively connected to the antenna and the memory, configured to control transmission and reception of the antenna by executing a computer-executable instruction stored in the memory, and implement the communication method according to any one of the first aspect and its possible implementations of the present disclosure.

According to a sixth aspect of the present disclosure, a communication device, such as a second communication device, is provided. The communication device includes: an antenna; a memory; and a processor, respectively connected to the antenna and the memory, configured to control transmission and reception of the antenna by executing a computer-executable instruction stored in the memory, and implement the communication method according to any one of the second aspect and its possible implementations of the present disclosure.

According to a seventh aspect of the present disclosure, a computer-readable storage medium is provided. Where the computer-readable storage medium stores a computer-executable instruction, and the computer-executable instruction is executed by a processor to implement the communication method according to any one of the first and second aspects and their possible implementations.

According to an eighth aspect of the present disclosure, a computer program or a computer program product is provided. When the computer program product is executed on a computer, the computer can implement the communication method according to any one of the first and second aspects and their possible implementations.

In the present disclosure, the first communication device indicates, to the second communication device, the model information of the first model used for training the encoder and/or the decoder of the first communication device or the model information of the first model suggested by the first communication device to be used for training the encoder or the decoder of the second communication device, so that the second communication device can quickly and accurately determine the second model used for training the encoder or the decoder of the second communication device. Subsequently, the second communication device can use the second model to train the encoder or the decoder on the side of the second communication device, thereby enhancing the training efficiency of the CSI compression two-side model.

It should be understood that the technical solutions of the third to eighth aspects of the present disclosure are consistent with those of the first and second aspects of the present disclosure, and the beneficial effects achieved by each aspect and the corresponding feasible implementations are similar, and will not be elaborated here.

### BRIEF DESCRIPTION OF DRAWINGS

FIG. 1 is a structural schematic diagram of a communication system in an embodiment of the present disclosure.

FIG. 2 is a schematic flow diagram of a training process starting from a side of UE in an embodiment of the present disclosure.

FIG. 3 is a schematic flow diagram of a training process starting from a side of a network device in an embodiment of the present disclosure.

FIG. 4 is a flow diagram of a first implementation process of a communication method performed by a first communication device in an embodiment of the present disclosure.

FIG. 5 is a flow diagram of a second implementation process of a communication method performed by a first communication device in an embodiment of the present disclosure.

FIG. 6 is a flow diagram of a first implementation process of a communication method performed by a network device in an embodiment of the present disclosure.

FIG. 7 is a flow diagram of a first implementation process of a communication method performed by a UE in an embodiment of the present disclosure.

FIG. 8 is a flow diagram of a first implementation process of a communication method performed by a second communication device in an embodiment of the present disclosure.

FIG. 9 is a flow diagram of a second implementation process of a communication method performed by a second communication device in an embodiment of the present disclosure.

FIG. 10 is a flow diagram of a second implementation process of a communication method performed by a UE in an embodiment of the present disclosure.

FIG. 11 is a flow diagram of a second implementation process of a communication method performed by a network device in an embodiment of the present disclosure.

FIG. 12 is a schematic flow diagram of a first implementation process of a communication method performed by a communication system in an embodiment of the present disclosure.

FIG. 13 is a schematic flow diagram of a second implementation process of a communication method performed by a communication system in an embodiment of the present disclosure.

FIG. 14 is a schematic structural diagram of a communication apparatus in an embodiment of the present disclosure.

FIG. 15 is a schematic structural diagram of a communication device in an embodiment of the present disclosure.

FIG. 16 is a schematic structural diagram of a terminal device in an embodiment of the present disclosure.

FIG. 17 is a schematic structural diagram of a network device in an embodiment of the present disclosure.

### DETAILED DESCRIPTION

Detailed descriptions of exemplary embodiments will be provided here, with their examples illustrated in the attached drawings. When the following descriptions refer to the drawings, unless otherwise indicated, the same numbers in different drawings represent the same or similar elements. The implementations described in the following exemplary embodiments do not represent all the implementations consistent with the embodiments of the present disclosure. Instead, they are merely examples of apparatuses and methods consistent with some aspects of the present application as detailed in the attached claims.

The terms used in the embodiments of the present disclosure are merely to describe specific embodiments and are not intended to limit the embodiments of the present disclosure. The singular forms “a”, “the”, and “said” used in the embodiments of the present disclosure and the attached claims are also intended to include the plural forms, unless the context clearly indicates a different meaning. It should also be understood that the term “and/or” as used herein refers to and includes any or all possible combinations of one or multiple associated listed items.

It should be understood that although the terms “first”, “second”, “third”, and the like are used, they may be used to describe various information in the embodiments of the present disclosure, and such information should not be limited to these terms. These terms are only used to distinguish one type of information from another. For example, without departing from the scope of the present disclosure, “a first information” may also be referred to as “a second information”, and similarly, “the second information” may also be referred to as “the first information”. Depending on the context, the term “if” as used herein can be interpreted as “when”, “upon”, or “in response to . . . , determining . . . ”.

The technical solutions provided by the embodiments of the present disclosure can be applied to the wireless communication between communication devices. The wireless communication between communication devices can include the wireless communication between network devices and terminal devices, the wireless communication between network devices, and the wireless communication between terminal devices. In the embodiments of the present disclosure, the term “wireless communication” can also be simply referred to as “communication”, and the term “communication” can also be described as “data transmission”, “information transmission”, or “transmission”.

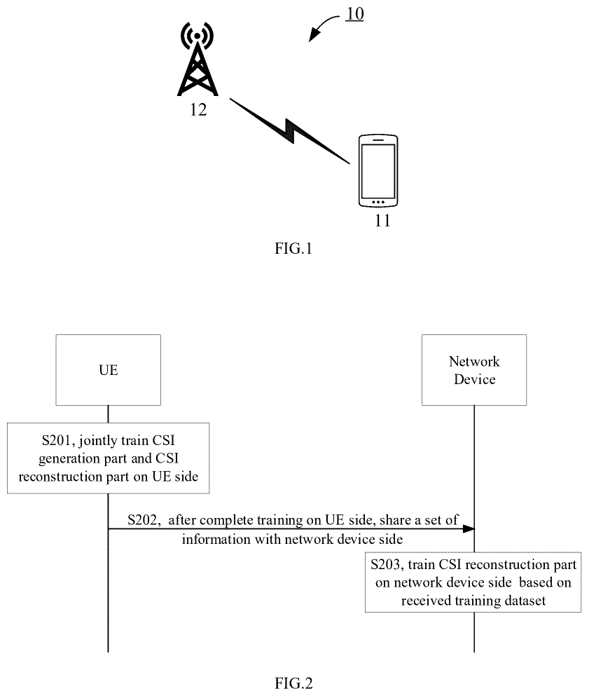

In the embodiments of the present disclosure, a communication system is provided. For example, the communication system can be a communication system that adopts cellular mobile communication technology. FIG. 1 is a structural schematic diagram of a communication system in an embodiment of the present disclosure. Referring to FIG. 1, the communication system 10 can include: a terminal device 11 and a network device 12.

In an embodiment, the terminal device 11 can be a device that provides voice or data connectivity to users. In some embodiments, the terminal device can also be referred to as user equipment (UE), a mobile station, a subscriber unit, a station, a terminal, or the like. The terminal device can be a cellular phone, a personal digital assistant (PDA), a wireless modem, a handheld device, a laptop computer, a cordless phone, a wireless local loop (WLL) terminal, a tablet computer, or the like. With the development of wireless communication technology, any device that can access the communication system, communicate with the network side of the communication system, or communicate with other devices through the communication system is the terminal device in the embodiments of the present disclosure. For example, the terminal device can be the terminal and the vehicle in intelligent transportation, the home device in smart homes, the power metering instrument, the voltage monitoring instrument and the environmental monitoring instrument in intelligent grids, the video surveillance instrument and the cash register in intelligent complete/comprehensive networks and the like. In the embodiments of the present disclosure, the terminal device can communicate with the network device, and multiple terminal devices can also communicate with each other. The terminal device can be static and fixed or mobile. For example, in the following embodiments, the terminal device is taken as the UE for illustration.

The network device 12 can be a device located on the side of the access network used to support the terminal access to the communication system. The network device 12 can include various forms of macro base stations, micro base stations (also described as small stations), relay stations, access points, and the like. In systems adopting different wireless access technologies, the name of the network device 12 may vary. For example, in 4G access technology communication systems, the name is an evolved NodeB (eNB), and in 5G access technology communication systems, the names are a next generation NodeB (gNB), a transmission reception point (TRP), a relay node, an access point (AP), and the like.

Hereinafter, a brief introduction to some terms and technologies involved in the embodiments of the present disclosure is provided.

### I. Model.

The “model” mentioned in the embodiments of the present disclosure is a trainable model used for training the CSI encoder and/or the CSI decoder, that is, a trainable model used for CSI compression or recovery. For example, the CSI encoder can be used for CSI compression, and the CSI decoder can be used for CSI recovery.

In an embodiment, the “model” can be any trainable model, such as an AI model, a neural network model, a deep learning model, a machine learning (ML) model, a Type 3 model, a Type 3 CSI compression and recovery model, and the like. The embodiments of the present disclosure do not limit the specific description or name of the model used for training the CSI encoder and/or the CSI decoder. For example, in the following embodiments, the model is used as the AI model for illustration, but the model can also be any other trainable encoding model and/or decoding model, which is not specifically limited here.

In an embodiment, the UE and the network device can perform CSI compression and recovery through the AI model. That is, the AI model is a neural network model used for CSI compression and/or recovery. Different AI models have different model information, such as a backbone network (AI backbone), a network structure (AI structure), a hyperparameter, a model parameter, and the like. In an embodiment, the model information of the model can be described as the model information of the AI model, the AI model information, and the like. The embodiments of the present disclosure do not limit the specific description or name of the model information.

For example, the backbone network of the AI model can refer to the basic network adopted by the AI model, such as a deep neural network (DNN) model, a convolutional neural network (CNN) model, a Transformer model, and the like. The network structure of the AI model can refer to the specific structure of the AI model. The hyperparameter of the AI model can refer to the tuning parameter in the machine learning algorithm, which is the variable that manage the training process itself, such as the learning rate in gradient descent, the number of nearest points in k-nearest neighbor, the depth of the tree in decision tree models, the number of latent factors in matrix factorization, the number of hidden layers in DNN, and the number of clusters in k-means clustering, and the like. The hyperparameter is usually set before the training process begins. The model parameter of the AI model can refer to the internal configuration variable of the model, such as the weight in a neural network, the support vector in a support vector machine, the coefficient in linear or logistic regression, and the like, whose values can be estimated based on the data. A model parameter is the operation performed on the data as it passes through the neural network.

In an embodiment, at least one of the backbone network, network structure, hyperparameter, and model parameter of the AI model can be specified in the communication protocol or configured by the network device for the UE. The embodiment of the present disclosure does not impose specific limitations on this.

In an embodiment, the AI model can be a non-single backbone network or a single backbone network. The embodiment of the present disclosure does not impose specific limitations on this.

In an embodiment, the “training” mentioned in the embodiment of the present disclosure can be described as “tuning”, “learning”, “parameter adjustment”, and the like. The present disclosure does not impose specific limitations on the description.

### II. Training Type of CSI-Compression Two-Side Model.

In the wireless communication network, the channel state should be measured by the UE, such as through the reference signal (CSI-reference signal, CSI-RS) sent by the network device and used for channel state information measurement. With the application of massive multiple-input multiple-output (MIMO) technology, the reporting overhead of the channel measurement result, that is, the channel state information (CSI), is increasing. Utilizing the AI model can effectively compress the reporting overhead of CSI while ensuring the accuracy of the CSI obtained on the side of the network (NW).

In an embodiment, the CSI compression sub-technology based on AI/ML can adopt a two-sided model. The two-sided model includes an AI/ML-based CSI generation part for generating CSI feedback information and an AI/ML-based CSI reconstruction part for reconstructing CSI from the received CSI feedback signal. The AI/ML-based CSI generation part is located on the side of the UE for CSI compression or CSI encoding. The AI/ML-based CSI reconstruction part is located on the side of NW (i.e., the side of the network device) for CSI decompression or CSI decoding.

In an embodiment, the AI/ML-based CSI generation part (hereinafter referred to as the “CSI generation part”) refers to the AI model used for generating CSI feedback information. The AI/ML-based CSI reconstruction part (hereinafter referred to as the “CSI reconstruction part”) refers to the AI model used for reconstructing the CSI feedback signal.

In an embodiment, the “CSI generation part” can also be described as the “encoding part”, “compression part”, or “encoder”, and the like. The present disclosure does not make specific limitations on the specific description or name of the two-side model.

In an embodiment, the “CSI reconstruction part” can also be described as the “decoding part”, “recovery part”, or “decoder”, and the like. The present disclosure does not make specific limitations on the specific description or name of the two-side model.

In an embodiment, the training collaboration of the two-side model can adopt the following types.
Type 1: the two-side model is jointly trained by a single side or an entity (such as the side of the UE or the side of the network device).
Type 2: the two-side model is jointly trained by the side of the UE and the side of the network device, respectively.
Type 3: separate training is performed by the side of the UE and the side of the network device, where the CSI generation part on the side of the UE and the CSI reconstruction part on the side of the network device are trained by the side of the UE and the side of the network device respectively.

Here, joint training refers to a process where the CSI generation part and the CSI reconstruction part are trained through forward and backward propagation in the same loop. Joint training can be conducted on a single node or across multiple nodes (for example, through gradient exchange between nodes). Separate training includes a sequential training starting from the side of UE (UE-first training), or a sequential training starting from the side of the network device (NW-first training).

For example, and in returning to the drawings, FIG. 2 is a schematic diagram of a training process starting from a side of the UE in an embodiment of the present disclosure, and the communication method can be applied to the described communication system(s). Referring to FIG. 2, the communication method can include S201-S203.

In S201, the UE jointly trains the CSI generation part and the CSI reconstruction part on the side of the UE (not for inference), that is, the encoder and the decoder on the side of the UE are trained.

In S202, after the training on the side of UE is completed, the side of UE shares a set of information (such as the training dataset) with the side of the network device, so that the side of the network device can train the CSI reconstruction part, that is, the decoder on the side of NW.

In S203, the side of the network device trains the CSI reconstruction part on the side of the network device based on the received training dataset.

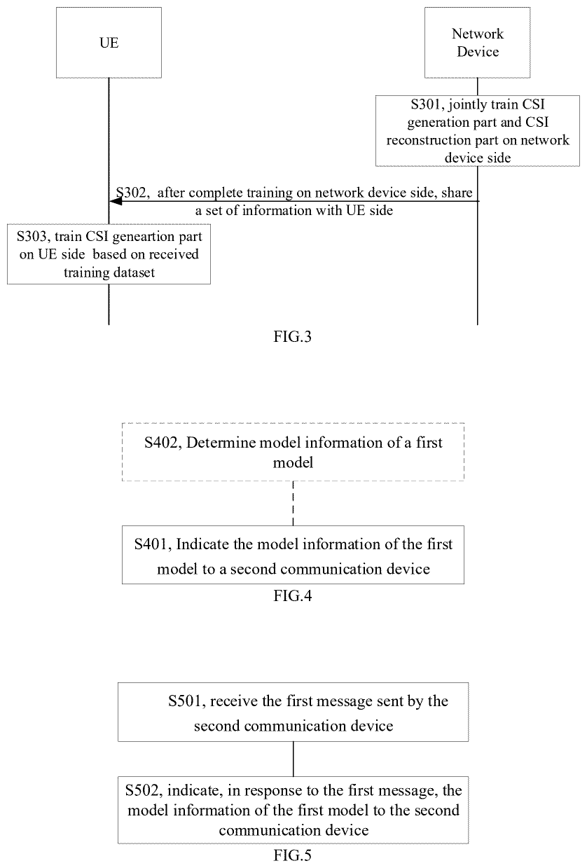

For example, FIG. 3 is a schematic diagram of a training process starting from a side of a network device in an embodiment of the present disclosure, and the communication method can be applied to the described communication system(s). Referring to FIG. 3, the communication method can include S301-S303.

In S301, the network device jointly trains the CSI generation part (not for inference) and the CSI reconstruction part on the side of the network device. That is, the encoder and the decoder on the side of NW are jointly trained.

In S302, after the training on the side of the network device is completed, the side of the network device shares a set of information (such as the training dataset) with the side of UE, so that the side of UE can train the CSI generation part, that is, the encoder on the side of UE.

In S303, the side of the UE trains the CSI generation part on the side of the UE based on the received training dataset.

In the embodiments of the present disclosure, for example, in FIGS. 2 and 3, unlike the joint training of Type 1, the separate training of Type 3 does not require the transmission of the complete AI model. The generation part (also referred to as the encoder) and the reconstruction part (also referred to as the decoder) of the AI CSI compression two-side model are trained separately on the side of the UE and the side of the network device. Under the structure of the two-side model for AI CSI compression, the performance is generally better when the generation part and the reconstruction part are in a paired model, and the amount of data in the training dataset required for the two-side model to converge is smaller.

In the embodiment of the present disclosure, a communication method is provided. The communication method can be applied to the first communication device. The first communication device can be the network device in any of the described communication systems, or the UE in any of the described communication systems.

In an embodiment, the first communication device can be the side that trains the two-side model first in the Type 3 training. For example, if the sequential training starts from the side of UE (UE-first training), the first communication device can be the UE; and if the sequential training starts from the side of the network device (NW-first training), the first communication device can be the network device.

In an embodiment, the second communication device can be the side that trains the two-side model later in the communication system. The second communication device is the other side, except for the first communication device. The second communication device trains the two-side model on the side of the second communication device through the training dataset shared by the first communication device. For example, if the first communication device is the UE, the second communication device can be the network device; and if the first communication device is the network device, the second communication device can be the UE.

As shown, FIG. 4 is a schematic diagram of a first implementation process of a communication method performed by a first communication device in an embodiment of the present disclosure. Referring to the solid-line box in FIG. 4, the communication method may include S401.

In S401, the model information of the first model is indicated/communicated to the second communication device.

In an embodiment, the first model can be the trainable model (such as the AI model) used by the encoder and/or the decoder on the side of the first communication device, or the first model can be the trainable model suggested by the first communication device to be used by the encoder or the decoder on the side of the second communication device.

In an embodiment, the first model (such as the first AI model) can be the model used by the first communication device to train the encoder and/or the decoder, or the first model can be the model suggested by the first communication device to be used by the second communication device to train the encoder or the decoder.

In an embodiment, “the trainable model suggested by the first communication device to be used by the encoder or the decoder on the side of the second communication device” can also be described as “the trainable model suggested by the first communication device and used for the encoder or the decoder on the side of the second communication device” or “the trainable model suggested by the first communication device to be used by the second communication device and used for the encoder or the decoder on the side of the second communication device”. Accordingly, the first AI model (i.e., the first model) can be the paired model of the AI model used by the encoder and/or the decoder on the side of the first communication device, such as an AI model with the same structure but opposite propagation direction or an AI model with the symmetrical structure, and the like. The embodiments of the present disclosure do not make specific limitations on this.

In an embodiment, after the model information of the first AI model indicated by the first communication device is obtained, the second communication device can choose to use the model information of the first AI model to determine the second AI model (which can also be described as the second model). Here, the second AI model is the trainable model used by the encoder or the decoder on the side of the second communication device. If the second communication device chooses to use the model information of the first AI model to determine the second AI model, the second AI model can be the first AI model or the paired model of the first AI model.

In an embodiment, after the training of the encoder and/or the decoder on the side of the first communication device is completed, the first communication device can share the training dataset with the second communication device to train the encoder or the decoder on the side of the second communication device based on the training dataset. To enable the second communication device to quickly determine the second AI model for training its own encoder or decoder, thereby improving the training efficiency of the CSI compression two-side model, the first communication device can also share the model information of the first AI model used for training its own encoder and/or decoder or the model information of the first AI model suggested to be used by the second communication device for training the encoder or the decoder with the second communication device. Thus, the first communication device performs S402 in addition to S401, to indicate the model information of the first AI model to the second communication device.

In an embodiment, the model information of the first AI model can include at least one of the backbone network (AI backbone), the network structure (AI structure), the hyperparameter, and the model parameter of the first AI model.

In an embodiment, referring to the dashed line in FIG. 4, before the S401 is performed, the first communication device can also perform S402.

In S402, the model information of the first model (which can also be described as the model information of the first AI model) is determined.

In an embodiment, when performing S402, the first communication device can determine the model information of the first AI model based on at least one of the AI capability of the second communication device, the general capability of the second communication device, and the communication protocol. Here, the AI capability of the second communication device can represent the capability of the second communication device in processing AI models.

For example, if the AI capability of the second communication device is low capability, the first communication device can share all or more of the model information of the first AI model with the second communication device. For instance, the first communication device can determine that the model information of the first AI model includes the backbone network, the network structure, the hyperparameter, and the model parameter of the first AI model. If the AI capability of the second communication device is high capability, the first communication device can share part or less of the model information of the first AI model with the second communication device. For instance, the first communication device can determine that the model information of the first AI model includes part of the backbone network, the network structure, the hyperparameter, and the model parameter of the first AI model. Or, if the communication protocol stipulates sharing all the model information of the AI model with the second communication device, the first communication device determines that the model information of the first AI model includes the backbone network, the network structure, the hyperparameter, and the model parameter of the first AI model. If the communication protocol stipulates sharing the backbone network of the AI model with the second communication device, the first communication device determines that the model information of the first AI model includes the backbone network of the first AI model. The first communication device can also determine the model information of the first AI model in other ways, and the embodiments of the present disclosure do not make specific limitations on this.

In an embodiment, when performing S402, the first communication device can directly send the model information of the first AI model to the second communication device to indicate the model information of the first AI model to the second communication device. For example, the first communication device determines the model information of the first AI model through S401. If the backbone network of the first AI model is CNN and the hidden layer is 3 layers, the first communication device sends the two fields of CNN and the number of hidden layers 3 to the second communication device. The model information of the first AI model can also have other situations, and the fields sent by the first communication device to the second communication device can also have other situations. The embodiments of the present disclosure do not make specific limitations on this.

In an embodiment, the first communication device carries the model information of the first AI model in at least one of the following: a radio resource control (RRC) signaling, a downlink control information (DCI), a control element (CE) of the media access control (MAC), other signaling carried by the physical downlink control channel (PDCCH), other signaling carried by the physical uplink shared channel (PUSCH), and other signaling carried by the physical downlink shared channel (PDSCH). The embodiments of the present disclosure do not make specific limitations on this.

In another embodiment, when performing S401, the first communication device can also indirectly indicate the model information of the first AI model to the second communication device. For example, the first communication device can send the first indication information to the second communication device, and the first indication information is used for indicating the model information of the first AI model.

In an embodiment, the first indication information can include at least one of the model name, the model description, or the model number of the first AI model. The model name of the first AI model can be the name of the backbone network of the first AI model (such as CNN, DNN, Transformer, and the like). The model description of the first AI model can include the trainer of the first AI model, the training method of the first AI model, the description information such as used for CSI compression, used for CSI recovery, and the like. The model number of the first AI model can be the number (can also be described as a code, an index, and the like) defined for the first AI model in the communication protocol. The first indication information can also include other information. The embodiments of the present disclosure do not make specific limitations on this.

For example, the first indication information can be AE_A_H_001, used for indicating an AI model (i.e., the first AI model) for CSI compression (autoencoder, AE) with Transformer (model number A) as the backbone network, trained by H Company (i.e., the trainer of the first AI model) in the 001 method (i.e., the training method). The first indication information can also be AD_CNN, used for indicating an AI model (i.e., the first AI model) for CSI recovery (auto decoder, AD) with CNN as the backbone network. These are only examples of the first indication information, and the first indication information can also have other specific implementations. The embodiments of the present disclosure do not make specific limitations on this.

Therefore, the first communication device indicates, to the second communication device, the model information of the first AI model used by the encoder and/or the decoder of the first communication device and/or the model information of the first AI model suggested by the first communication device to be used by the second communication device, so that the second communication device can quickly and accurately determine the second model based on the model information of the first AI model. Subsequently, the second communication device can use the second AI model to train the encoder or the decoder on the side of the second communication device, thereby the training efficiency of the CSI compression two-side model is enhanced.

In some possible implementations, FIG. 5 is a schematic diagram of a second implementation process of a communication method performed by a first communication device in an embodiment of the present disclosure. Referring to FIG. 5, the communication method may include S501 to S502.

In S501, the first message sent by the second communication device is received.

In S502, in response to the first message, the model information of the first model is indicated to the second communication device.

The first message is used for requesting the model information of the first AI model from the first communication device. For example, the first message can be a request message.

In an embodiment, the first message can be at least one of a broadcast message, a system message, a unicast message, or a multicast message.

In an embodiment, the second communication device can determine whether it needs the first communication device to indicate the model information of the first AI model based on its own AI capability. If needed, the second communication device can send the first message to the first communication device. Accordingly, the first communication device performs S501. For example, if the AI capability of the second communication device is strong, the second communication device may not request the first communication device to indicate the model information of the first AI model. If the AI capability of the second communication device is weak, the second communication device can request the first communication device to indicate the model information of the first AI model. Accordingly, the second communication device sends the request message to the first communication device, and the first communication device performs S501. Here, the AI capability of the second communication device can represent the capability of the second communication device in processing AI models.

It should be noted that with respect to the specific description of S501 to S502, the description of S401 in FIG. 4 can be referred to. For the sake of brevity, it will not be elaborated here.

In an embodiment, when performing S502, the first communication device can first determine the model information of the first AI model and then indicate the model information of the first AI model to the second communication device.

It should be noted that with respect to the specific description of the step that the first communication device determines the model information of the first AI model, the description of S402 in FIG. 4 can be referred to. For the sake of brevity, it will not be elaborated here.

Therefore, the second communication device sends the first message based on its own needs to request the model information of the first AI model from the first communication device. The first communication device indicates, in response to the first message, the model information of the first AI model to the second communication device. Thus, the second communication device can quickly and accurately determine the second AI model based on the model information of the first AI model. Subsequently, the second communication device can use the second AI model to train the encoder or the decoder on the side of the second communication device, thereby the training efficiency of the CSI compression two-side model is enhanced.

It should be noted that the embodiment of FIG. 5 can be performed independently or in combination with any embodiment of FIG. 4. In the absence of conflict, the performing order of each step can be arbitrarily exchanged.

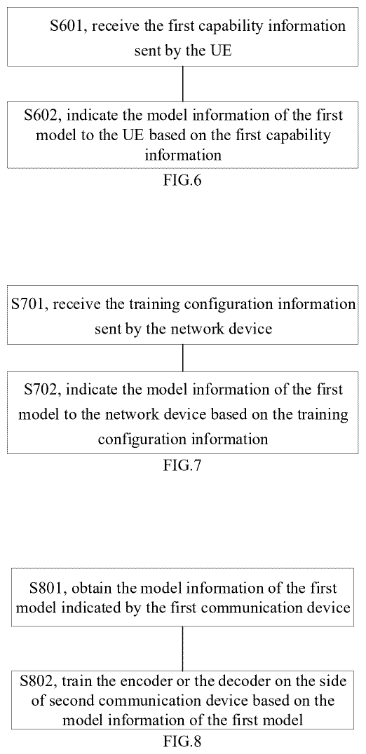

In some possible implementations, for NW-first training, the first communication device is the network device, and the second communication device is UE. In this case, FIG. 6 is a schematic diagram of a first implementation process of a communication method performed by a network device in an embodiment of the present disclosure. Referring to FIG. 6, the communication method may include S601 to S602.

In S601, the first capability information sent by the second communication device (i.e., UE) is received.

In S602, the model information of the first model is indicated to the UE based on the first capability information.

In an embodiment, the first capability information is at least used for indicating the AI capability of the UE (UE AI capability). Here, the AI capability of the UE can represent the capability of the UE in processing AI models.

In an embodiment, the first capability information is used for requesting the UE to indicate the model information of the first model to the network device.

In an embodiment, the first capability information can include at least one parameter for representing the capability of UE in processing AI models. For example, the first capability information can include at least one of the following parameters: the training method of the AI model used (or capable of being used) by the UE, the backbone network of the AI model supported (or capable of being supported) by the UE, the quantization precision supported (or capable of being supported) by the UE, the quantization method supported (or capable of being supported) by the UE, the number of AI models stored (or capable of being stored) by the UE, the memory size used (or capable of being used) by the UE for storing AI models, the processing time of the UE relative to a baseline model, the number of times the UE can run a single AI model within a unit time (i.e., the number of times the AI model is run within a unit time), the processing time of a single AI model (i.e., the time required for a single AI model to complete one operation), and the like. The AI processing capability of the UE can also be represented by other parameters, and the first capability information can include other parameters. The embodiment of the present disclosure does not make specific limitations on this.

In another embodiment, the first capability information can include the capability level of the UE in processing AI models. For example, based on at least one parameter representing the capability of UE in processing AI models, the capability of UE in processing AI models can be divided into multiple levels, such as a low capability, a middle capability, and a high capability; or, a capability 1, a capability 2, a capability 3, and the like. Different capability levels indicate different AI model processing capabilities. The capability level of the UE in processing AI models can also be represented by other methods, and the embodiments of the present disclosure do not make specific limitations on this.

In an embodiment, the first capability information representing the capability of UE in processing AI models can be quantified processing capability, such as quantified value information, a quantified table preset in a communication protocol, and the like. The embodiments of the present disclosure do not make specific limitations on this.

In an embodiment, the first capability information can also indicate the general capability of the UE (such as UE capability). The embodiments of the present disclosure do not make specific limitations on this.

In an embodiment, S601 can be performed periodically, or can be sent together with other information when the UE sends information to the network device, or can be performed when the UE starts training the encoder and/or the decoder on the side of the UE, or can be performed when the UE receives the training dataset sent by the network device. The embodiment of the present disclosure does not make specific limitations on this. For example, the other information can be any information sent by the UE to the network device.

In an embodiment, the first capability information can be carried in the same signaling as the other information and sent, or can be carried in different signaling and sent respectively.

In another embodiment, the first capability information can be sent within the other information.

In an embodiment, the first capability information can be carried in the first message sent by the UE through S501 in the FIG. 5 embodiment. For example, the first capability information can be carried in a request message and sent to the network device, to save signaling overhead.

In an embodiment, when performing S602, the network device can first determine the model information of the first AI model based on the first capability information, that is, the capabilities of UE (such as the general capability of the UE (UE capability), the AI capability of UE, and the like), and then indicate the model information of the first AI model to the UE.

For example, if the AI capability of the UE is low capability, the network device can share all or more of the model information of the first AI model with the UE. For instance, the network device can determine that the model information of the first AI model includes the backbone network of the first AI model, the network structure of the first AI model, the hyperparameter of the first AI model, and the model parameter of the first AI model. If the AI capability of the UE is high capability, the network device can share part or less of the model information of the first AI model with the UE. For instance, the network device can determine that the model information of the first AI model includes part of the backbone network of the first AI model, the network structure of the first AI model, the hyperparameter of the first AI model, and the model parameter of the first AI model. The network device can determine the corresponding model information of the first AI model based on the different first capability information. The embodiment of the present disclosure does not make specific limitations on this.

It should be noted that with respect to the specific description of the step that the network device indicates the model information of the first model to the UE in S602, the description of S401 in FIG. 4 can be referred to. For the sake of brevity, it will not be elaborated here.

Therefore, the network device determines the model information of the first AI model based on the first capability information sent by the UE and indicates the model information to the UE. Thus, the UE can quickly and accurately determine the second AI model based on the model information of the first AI model. Subsequently, the UE can use the second AI model to train the encoder or the decoder on the side of the UE, thereby the training efficiency of the CSI compression two-side model is enhanced.

It should be noted that the embodiment of FIG. 6 can be performed independently or in combination with any embodiment of FIGS. 4 and 5. In the absence of conflict, the performing order of each step can be arbitrarily exchanged.

In some possible implementations, for UE-first training, the first communication device is the UE and the second communication device is the network device. In this case, FIG. 7 is a schematic diagram of a first implementation process of a communication method performed by a UE in an embodiment of the present disclosure. Referring to FIG. 7, the communication method may include S701 to S702.

In S701, the training configuration information sent by the second communication device (i.e., the network device) is received.

In S702, the model information of the first model is indicated to the network device based on the training configuration information.

In an embodiment, the training configuration information is used for configuring at least one model information of the AI model indicated by the UE to the network device (or can also be described as reported by the UE).

In an embodiment, the training configuration information can be used for requesting the UE to indicate at least one model information of the AI model to the network device.

In an embodiment, when the network device trains the decoder, the network device can configure the relevant information of the AI model and carry the information in the training configuration information to send to the UE, so that the UE can indicate the model information of the first AI model to the network device based on the configuration of the network device, for the network device to train its own decoder.

For example, the training configuration information may include at least one of the following: a parameter for indicating whether the UE indicates the model information of the first AI model to the network device, a parameter for indicating which or which several model information of the first AI model the UE specifically indicates to the network device, a parameter for indicating whether the UE directly or indirectly indicates the model information of the first AI model to the network device, and a parameter for indicating which training type the UE uses to train the encoder and/or the decoder. The network device can also configure other parameters for training the decoder on the side of the network device, such as the training dataset. Accordingly, the training configuration information may also include data of other parameters such as the training dataset. The embodiments of the present disclosure do not make specific limitations on this.

In an embodiment, when performing S702, if the training configuration information includes the parameter for indicating whether the UE indicates the model information of the first AI model to the network device, the UE can indicate the model information of the first AI model to the network device. For example, if the training configuration information indicates that the UE indicates the model information of the first AI model to the network device, the UE can indicate the parameters of the model information of the first AI model to the network device based on its own AI capability, general capability, and communication protocol stipulates, and the like.

In another embodiment, when performing S702, if the training configuration information includes a parameter for indicating which or which several model information of the AI model the UE specifically indicates to the network device, the UE can indicate this one or several model information of the first AI model to the network device. For example, if the training configuration information indicates that the UE indicates the backbone network and the hyperparameter of the AI model to the network device, the UE can indicate the backbone network (such as CNN) and the hyperparameter (such as the hidden layer is 3 layers) of the first AI model to the network device. The UE can indicate the corresponding model information of the first AI model to the network device based on the configuration of the training configuration information. The embodiment of the present disclosure does not make specific limitations on this.

In an embodiment, when performing S702, the UE can first determine the model information of the first AI model based on the training configuration information, and then indicate the model information of the first AI model to the network device.

For example, if the training configuration information indicates that the UE indicates the model information of the AI model to the network device, the UE can determine the model information of the first AI model based on its own AI capability, general capability, and communication protocol stipulates, and the like, and then indicate the model information to the network device. If the training configuration information indicates that the UE indicates the backbone network and the hyperparameter of the AI model to the network device, the UE can determine the backbone network (such as CNN) and the hyperparameter (such as the hidden layer is 3 layers) of the first AI model as the model information of the first AI model, and then indicate the model information to the network device. The UE can determine the corresponding model information of the first AI model based on different configurations of the training configuration information and then indicate the model information to the network device. The embodiment of the present disclosure does not make specific limitations on this.

It should be noted that with respect to the specific description of the step of the UE indicating the model information of the first model to the network device in S702, the description of S401 in FIG. 4 can be referred to. For the sake of brevity, it will not be elaborated here.

In an embodiment, the training configuration information can be carried in the first message sent by the network device through S501 in FIG. 5. For example, the training configuration information can be carried in a request message and sent to the UE, to save signaling overhead.

It should be noted that with respect to the specific description of S703, the description of S402 in FIG. 4 can be referred to. For the sake of brevity, it will not be elaborated here.

Therefore, the UE determines the model information of the first AI model based on the training configuration information configured by the network device and indicates the model information to the network device. Thus, the network device can quickly and accurately determine the AI model (such as the second AI model) paired with the model information of the first AI model based on the model information of the first AI mode. Subsequently, the UE can use the second AI model to train the encoder on the side of UE, thereby the training efficiency of the CSI compression two-side model is enhanced.

It should be noted that the embodiment of FIG. 7 can be performed independently or in combination with any embodiment of FIGS. 4 and 5. In the absence of conflict, the performing order of each step can be arbitrarily exchanged.

As shown, FIG. 8 is a schematic diagram of a first implementation process of a communication method performed by a second communication device in an embodiment of the present disclosure. Referring to FIG. 8, the communication method can include S801 to S802.

In an embodiment, the second communication device can be one side of the communication system that trains the two-side model later, and is the other side except for the first communication device. The second communication device trains its own side of the two-side model through the training data set shared by the first communication device. For example, if the sequential training starts from the side of ULE (UE-first training), the first communication device can be the UE, and the second communication device can be the network device; and if the sequential training starts from the side of the network device (NW-first training), the first communication device can be the network device, and the second communication device can be the UE.

In S801, the model information of the first model indicated by the first communication device is obtained.

In S802, the encoder or the decoder on the side of the second communication device is trained based on the model information of the first model.

The first model (such as the first AI model) can be the trainable model (such as an AI model) used by the encoder and/or the decoder on the side of the first communication device, or the first model can be the trainable model suggested by the first communication device to be used by the encoder or the decoder on the side of the second communication device.

In an embodiment, the “the trainable model suggested by the first communication device to be used by the encoder or the decoder on the side of the second communication device” can also be described as “the trainable model suggested by the first communication device and used for the encoder or the decoder on the side of the second communication device” or “the trainable model suggested by the first communication device to be used by the second communication device and used for the encoder or the decoder on the side of the second communication device”. Accordingly, the first model can be the paired model of the AI model used by the first communication device to train its own encoder and/or decoder, such as the AI model with the same structure but opposite propagation direction or the AI model with the symmetrical structure, and the like. The embodiment of the present disclosure does not make specific limitations on this.

In an embodiment, after the model information of the first AI model indicated by the first communication device is obtained, the second communication device can choose or not choose to train its own encoder or decoder based on the model information of the first AI model. If the second communication device chooses to train its own encoder or decoder based on the model information of the first AI model, the second communication device will perform S802. For example, for UE-first training, the network device can use the second AI model to train the decoder on the side of the network device; for NW-first training, the ULE can use the second AI model to train the encoder on the side of UE.

In an embodiment, when performing S802, the second communication device can first determine the second model based on the model information of the first model, and then use the second model to train the encoder or the decoder on the side of the second communication device. The second model (such as the second AI model) can be the trainable model used by the encoder or the decoder on the side of the second communication device. If the second communication device chooses to use the model information of the first AI model to determine the second AI model, the second AI model can be the first AI model or the paired model of the first AI model.

In an embodiment, after the training of the encoder and/or the decoder on the side of the first communication device is completed, the first communication device can share the training dataset with the second communication device to train the encoder or the decoder on the side of the second communication device based on the training dataset. To enable the second communication device to quickly determine the second AI model for training its own encoder or decoder, thereby improving the training efficiency of the CSI compression two-side model, the first communication device can also share the model information of the first AI model used for training its own encoder and/or the decoder or the model information of the first AI model suggested to be used by the second communication device for training the encoder or the decoder with the second communication device. Thus, the second communication device performs S801 to S802 to obtain the model information of the first AI model indicated by the first communication device, and then determines the second AI model and uses the second AI model to train the encoder or the decoder on the side of the second communication device.

In an embodiment, the model information of the first AI model can include at least one of the backbone network (AI backbone), the network structure (AI structure), the hyperparameter, and the model parameter of the first AI model.

In an embodiment, the first communication device can directly send the model information of the first AI model to the second communication device to indicate the model information of the first AI model to the second communication device. Accordingly, in S801, the second communication device receives the model information of the first AI model sent by the first communication device. For example, the first communication device determines the model information of the first AI model, such as the two fields that the backbone network of the first AI model is CNN and the number of hidden layers is 3. Then, the first communication device sends the two fields of CNN and the number of hidden layers 3 to the second communication device. Accordingly, the second communication device receives the two fields of CNN and the number of hidden layers 3. The model information of the first AI model can also have other situations, and the fields sent by the first communication device to the second communication device can also have other situations. The embodiment of the present disclosure does not make specific limitations on this.

In an embodiment, the model information of the first AI model can be carried in at least one of RRC signaling, DCI, MAC CE, other signaling carried by PDCCH, other signaling carried by PUSCH, and other signaling carried by PDSCH. The embodiment of the present disclosure does not make specific limitations on this.

In another embodiment, the first communication device can also indirectly indicate the model information of the first AI model to the second communication device. For example, the first communication device can send first indication information to the second communication device, and the first indication information is used for indicating the model information of the first AI model. Accordingly, in S801, the second communication device receives the first indication information sent by the first communication device.

In an embodiment, the first indication information can include at least one of the model name, the model description, or the model number of the first AI model. The model name of the first AI model can be the name of the backbone network of the first AI model (such as CNN, DNN, Transformer, and the like). The model description of the first AI model can include the trainer of the first AI model, the training method of the first AI model, the description information such as used for CSI compression, used for CSI recovery, and the like. The model number of the first AI model can be the number (can also be described as a code, an index, and the like) defined for the first AI model in the communication protocol. The first indication information can also include other information. The embodiments of the present disclosure do not make specific limitations on this.

For example, the first indication information can be AE_A_H_001, used for indicating an AI model (i.e., the first AI model) for CSI compression (autoencoder, AE) with Transformer (model number A) as the backbone network, trained by H Company (i.e., the trainer of the first AI model) in the 001 method (i.e., the training method). The first indication information can also be AD_CNN, used for indicating an AI model (i.e., the first AI model) for CSI recovery (auto decoder, AD) with CNN as the backbone network. These are only examples of the first indication information, and the first indication information can also have other specific implementations. The embodiments of the present disclosure do not make specific limitations on this.

In an embodiment, since the AI model used by the encoder and/or the decoder on the first communication device and the AI model used by the encoder or the decoder on the second communication device are paired models, the second AI model can be the first AI model or the AI model paired with the first AI model, such as an AI model with the same structure but opposite propagation direction or an AI model with the symmetrical structure, and the like. The embodiments of the present disclosure do not make specific limitations on this.

Therefore, the second communication device obtains the model information of the first AI model indicated by the first communication device, which is used by the encoder and/or the decoder on the side of the first communication device or suggested by the first communication device to be used by the second communication device. Thus, the second communication device can quickly and accurately determine the second AI model based on the model information of the first AI model. Subsequently, the second communication device can use the second AI model to train the encoder or the decoder on the side of the second communication device, thereby the training efficiency of the CSI compression two-side model is enhanced.

In some possible embodiments, FIG. 9 is a schematic diagram of a second implementation process of a communication method performed by a second communication device in an embodiment of the present disclosure. Referring to FIG. 9, the communication method can include S901 to S903.

In S901, the first message is sent to the first communication device.

In S902, the model information of the first model (such as the first AI model) indicated, in response to the first message, by the first communication device is obtained.

In S903, the encoder or the decoder on the side of the second communication device is trained based on the model information of the first model.

The first message is used for requesting the model information of the first model from the first communication device. For example, the first message can be the request message.

In an embodiment, the first message can be at least one of the broadcast message, the system message, the unicast message, or the multicast message.

In an embodiment, the second communication device can determine whether it needs the first communication device to indicate the model information of the first AI model based on its own AI capability. If needed, the second communication device can perform S901 and send the first message to the first communication device. For example, if the AI capability of the second communication device is strong, the second communication device may not request the first communication device to indicate the model information of the first AI model. If the AI capability of the second communication device is weak, the second communication device can request the first communication device to indicate the model information of the first AI model, and then perform S901. Here, the AI capability of the second communication device can represent the capability of the second communication device in processing AI models.

In an embodiment, the first communication device can indicate, in response to the first message, the model information of the first AI model to the second communication device. Accordingly, the second communication device performs S902. For example, the first communication device can directly or indirectly indicate the model information of the first AI model to the second communication device. Accordingly, in S902, the second communication device can receive the model information of the first AI model or the first indication information sent by the first communication device.

It should be noted that with respect to the specific description of S902 to S903, the description of S801 to S802 in FIG. 8 can be referred to. For the sake of brevity, it will not be elaborated here.

In an embodiment, after the model information of the first AI model indicated by the first communication device is obtained, the second communication device can choose or not choose to train its own encoder or decoder based on the model information of the first AI model. If the second communication device chooses to train its own encoder or decoder based on the model information of the first AI model, the second communication device will perform S903. For example, for UE-first training, the network device can use the second AI model to train the decoder on the side of the network device; for NW-first training, the UE can use the second AI model to train the encoder on the side of UE.

In an embodiment, when performing S903, the second communication device can first determine the second model based on the model information of the first model, and then use the second model to train the encoder or the decoder on the side of the second communication device. The second model (such as the second AI model) can be the trainable model used by the encoder or the decoder on the side of the second communication device. If the second communication device chooses to use the model information of the first AI model to determine the second AI model, then since the AI model used by the encoder and/or the decoder on the side of the first communication device and the AI model used by the encoder or the decoder on the side of the second communication device are paired models, the second AI model can be the first AI model, or the AI model paired with the first AI model, such as the AI model with the same structure but opposite propagation direction or the AI model with the symmetrical structure, and the like. The embodiment of the present disclosure does not make specific limitations on this.

Therefore, the second communication device sends the first message based on its own needs to request the model information of the first AI model from the first communication device. The first communication device indicates, in response to the first message, the model information of the first AI model to the second communication device. Thus, the second communication device can quickly and accurately determine the second AI model based on the model information of the first AI model. Subsequently, the second communication device can use the second AI model to train the encoder or the decoder on the side of the second communication device, thereby the training efficiency of the CSI compression two-side model is enhanced.

It should be noted that the embodiment of FIG. 9 can be performed independently or in combination with any embodiment of FIG. 8. In the absence of conflict, the performing order of each step can be arbitrarily exchanged.

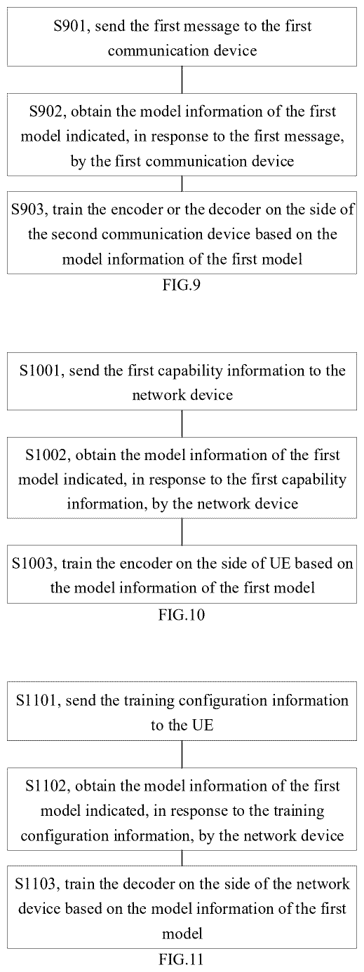

In some possible implementations, for NW-first training, the first communication device is the network device, and the second communication device is UE. In this case, FIG. 10 is a schematic diagram of a second implementation process of a communication method performed by a UE in an embodiment of the present disclosure. Referring to FIG. 10, the communication method can include S1001 to S1003.

In S1001, the first capability information is sent to the first communication device (i.e., the network device).

In S1002, the model information of the first model (such as the first AI model) indicated, in response to the first capability information, by the network device is obtained.

In S1003, the encoder on the side of UE is trained based on the model information of the first model.

The first capability information is at least used for indicating the AI capability of the UE (UE AI capability). Here, the AI capability of the UE can represent the capability of UE in processing AI models.

In an embodiment, the first capability information can include at least one parameter for representing the capability of UE in processing AI models, For example, the first capability information can include at least one of the following parameters: the training method of the AI model used (or capable of being used) by the UE, the backbone network of the AI model supported (or capable of being supported) by the UE, the quantization precision supported (or capable of being supported) by the UE, the quantization method supported (or capable of being supported) by the UE, the number of AI models that the UE stores (or is capable of storing), the memory size used (or capable of being used) by the UE for storing AI models, the processing time of the UE relative to a baseline model, the number of times the UE can run a single AI model within a unit time (i.e., the number of times the AI model can be run within a unit time), the processing time of a single AI model (i.e., the time required for a single AI model to complete one operation), and the like. The AI processing capability of the UE can also be represented by other parameters, and the first capability information can also include other parameters. The embodiment of the present disclosure does not make specific limitations on this.

In another embodiment, the first capability information can include the capability level of the UE for processing AI models. For example, based on at least one parameter representing the capability of UE in processing AI models, the capability of UE in processing AI models can be divided into multiple levels, such as a low capability, a middle capability, and a high capability; or, a capability 1, a capability 2, a capability 3, and the like. Different capability levels indicate different AI model processing capabilities. The capability level of the UE in processing AI models can also be represented by other methods, and the embodiments of the present disclosure do not make specific limitations on this.

In an embodiment, the first capability information representing the capability of UE in processing AI models can be quantified processing capability, such as quantified value information, a quantified table preset in a communication protocol, and the like. The embodiments of the present disclosure do not make specific limitations on this.

In an embodiment, the first capability information can also indicate the general capability of the UE (such as UE capability). The embodiment of the present disclosure does not make specific limitations on this.

In an embodiment, S1001 can be performed periodically, or can be sent together with other information when the UE sends information to the network device, or can be performed when the UE starts training the encoder and/or the decoder on the side of the UE, or can be performed when the UE receives the training dataset sent by the network device. The embodiment of the present disclosure does not make specific limitations on this. For example, the other information can be any information sent by the UE to the network device.

In an embodiment, the first capability information can be carried in the same signaling as the other information and sent, or can be carried in different signaling and sent respectively.

In another embodiment, the first capability can be sent within the other information.

In an embodiment, the first capability information can be carried in the first message sent by the UE through S901 in the FIG. 9 embodiment. For example, the first capability information can be carried in a request message and sent to the network device, to save signaling overhead.

It should be noted that with respect to the specific description of S1002 to S1003 mentioned, the description of S801 to S802 in FIG. 8 can be referred to. For the sake of brevity, it will not be elaborated here.

In an embodiment, after the model information of the first AI model indicated by the network device is obtained, the UE can choose or not choose to train its own encoder based on the model information of the first AI model according to its own situation. If the UE chooses to train its own encoder based on the model information of the first AI model, the network device will perform S1003.

In an embodiment, when performing S1003, the UE can first determine the second model based on the model information of the first model, and then use the second model to train the encoder on the side of the UE. The second model (such as the second AI model) can be the trainable model used by the encoder on the side of the UE. If the UE chooses to use the model information of the first AI model to determine the second AI model, since the AI model used by the encoder and/or the decoder on the side of the network device and the AI model used by the encoder on the side of the UE are paired models, the second AI model can be the first AI model or the AI model paired with the first AI model, such as the AI model with the same structure but opposite propagation direction or the AI model with the symmetrical structure, and the like. The embodiment of the present disclosure does not make specific limitations on this.

Therefore, the UE obtains the model information of the first AI model determined by the network device based on the first capability information sent by the UE and indicated the model information to the UE. Thus, the UE can quickly and accurately determine the second AI model based on the model information of the first AI model. Subsequently, the UE can use the second AI model to train the encoder or the decoder on the side of the UE, thereby the training efficiency of the CSI compression two-side model is enhanced.

It should be noted that the embodiment of FIG. 10 can be performed independently or in combination with any embodiment of FIGS. 8 and 9. In the absence of conflict, the performing order of each step can be arbitrarily exchanged.

In some possible implementations, for UE-first training, the first communication device is the UE and the second communication device is the network device. In this case, FIG. 11 is a schematic diagram of a second implementation process of a communication method performed by a network device in an embodiment of the present disclosure. Referring to FIG. 11, the communication method may include S1101 to S1103.

In S1101, the training configuration information is sent to the first communication device (i.e., the UE).

In S1102, the model information of the first model (such as the first AI model) indicated, in response to the training configuration information, by the second communication device (i.e., the network device) is obtained.

In S1103, the decoder on the side of the network device is trained based on the model information of the first model.

In an embodiment, the training configuration information is used for configuring at least one model information of the AI model indicated by the UE to the network device (or can also be described as reported by the UE).

In an embodiment, the training configuration information can be used for requesting the UE to indicate at least one model information of the AI model to the network device.

In an embodiment, when the network device trains the decoder, the network device can configure the relevant parameters of the AI model and carry these parameters in the training configuration information to send to the UE, so that the UE can indicate the model information of the first AI model to the network device based on the configuration of the network device, for the network device to train its own decoder. Accordingly, the network device performs S1101.

For example, the training configuration information may include at least one of the followings: a parameter for indicating whether the UE indicates the model information of the first AI model to the network device, a parameter for indicating which or which several model information of the first AI model the UE specifically indicates to the network device, a parameter for indicating whether the UE directly or indirectly indicates the model information of the first AI model to the network device, and a parameter for indicating which training type the UE uses to train the encoder and/or the decoder. The network device may also configure other parameters for training the decoder on the side of the network device, such as the training data set. Accordingly, the training configuration information may also include data of other parameters such as the training data set. The embodiments of the present disclosure do not make specific limitations on this.

In an embodiment, if the training configuration information includes the parameter for indicating whether the UE indicates the model information of the first AI model to the network device, the UE is instructed to indicate the model information of the first AI model to the network device, and the network device then performs S1102. For example, if the training configuration information indicates that the UE indicates the model information of the first AI model to the network device, the UE may indicate the model information of the first AI model to the network device based on its own AI capabilities, general capabilities, and communication protocol stipulates, and the like. Accordingly, the network device performs S1102.

In another embodiment, if the training configuration information includes a parameter for indicating which or which several model information of the AI model the UE specifically indicates to the network device, the UE may indicate this one or several model information of the first AI model to the network device, and the network device then performs S1102. For example, if the training configuration information indicates that the UE indicates the backbone network and the hyperparameter of the AI model to the network device, the UE can indicate the backbone network (such as CNN) and the hyperparameter (such as the hidden layer is 3 layers) of the first AI model to the network device. Accordingly, the network device performs S1102. The UE may indicate the corresponding model information of the first AI model to the network device based on different configurations of the training configuration information, and the network device obtains the indicated model information of the first AI model. The embodiments of the present disclosure do not make specific limitations on this.

In an embodiment, the training configuration information can be carried in the first message sent by the network device through S501 in FIG. 5. For example, the training configuration information can be carried in a request message and sent to the UE, to save signaling overhead.

In an embodiment, after the model information of the first AI model indicated by the UE is obtained, the network device can choose or not choose to train its own decoder based on the model information of the first AI model. If the network device chooses to train its own decoder based on the model information of the first AI model, the network device will perform S1103.

In an embodiment, when performing S1103, the network device can first determine the second model based on the model information of the first model, and then use the second model to train the decoder on the side of the network device. The second model (such as the second AI model) may be the trainable model used by the decoder on the side of the network device. If the network device chooses to determine the second AI model based on the model information of the first AI model, since the AI model used by the encoder and/or the decoder on the side of UE and the AI model used by the decoder on the side of the network device are paired models, the second AI model can be the first AI model or the AI model paired with the first AI model, such as the AI model with the same structure but opposite propagation direction or the AI model with the symmetrical structure, and the like. The embodiment of the present disclosure does not make specific limitations on this.

It should be noted that with respect to the specific description of S1103, the description of S802 in FIG. 8 can be referred to. For the sake of brevity, it will not be elaborated here.

Therefore, the network device receives the model information of the first AI model determined by the UE based on the training configuration information configured by the network device. Thus, the network device can quickly and accurately determine the second AI model based on the model information of the first AI model. Subsequently, the network device can use the second AI model to train the encoder or the decoder on the side of the network device, thereby the training efficiency of the CSI compression two-side model is enhanced.

It should be noted that the embodiment of FIG. 11 can be performed independently or in combination with any embodiment of FIGS. 8 and 9. In the absence of conflict, the performing order of each step can be arbitrarily exchanged.

In one or multiple of the embodiments, the “first AI model” can be one AI model or two or more different AI models. The embodiments of the present disclosure do not make specific limitations on this.

In an embodiment, the following provides a specific example to illustrate the communication method.

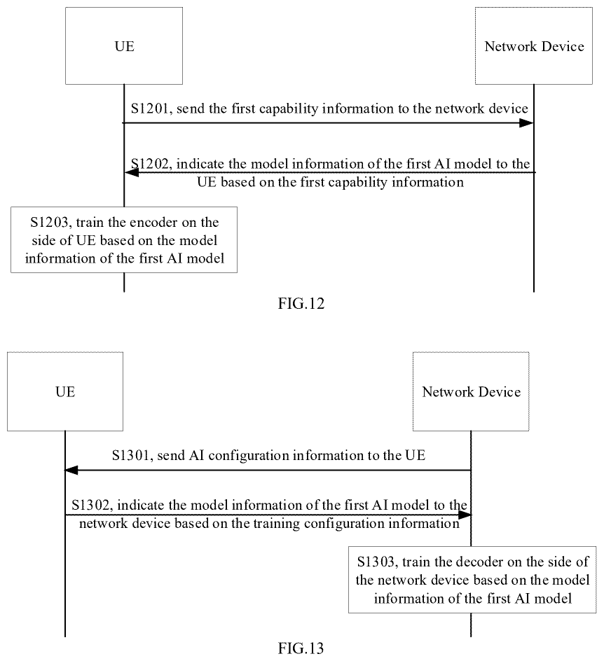

Suppose, for NW-first training, the first communication device is the network device and the second communication device is the UE. FIG. 12 is a schematic diagram of a first implementation process of a communication method performed by a communication system in an embodiment of the present disclosure. Referring to FIG. 12, the communication method may include S1201 to S1203.

In S1201, the UE sends the first capability information to the network device.

In S1202, the network device indicates the model information of the first AI model to the UE based on the first capability information.

In S1203, the UE trains the encoder on the side of UE based on the model information of the first AI model.

It should be noted that with respect to the specific descriptions of S1201 to S1203, the descriptions of the related steps in FIGS. 4, 6, 8, and 10 can be referred to. For the sake of brevity, it will not be elaborated here.

In an embodiment, the embodiment of FIG. 12 can be performed independently or in combination. In the absence of conflict, the execution order of each step can be arbitrarily exchanged.

In another embodiment, the following provides another specific example to illustrate the communication method(s).

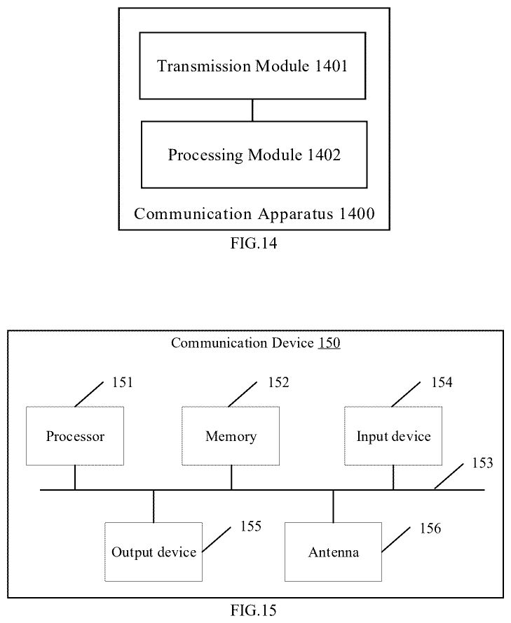

Suppose, for UE-first training, the first communication device is the UE and the second communication device is the network device. FIG. 13 is a schematic diagram of a second implementation process of a communication method performed by a communication system in an embodiment of the present disclosure. Referring to FIG. 13, the communication method may include S1301 to S1303.

In S1301, the network device sends the training configuration information to the UE.

In S1302, the UE indicates the model information of the first AI model to the network device based on the training configuration information.

In S1303, the network device trains the decoder on the side of the network device based on the model information of the first AI model.

It should be noted that with respect to the specific descriptions of S1301 to S1303, the descriptions of the related steps in FIGS. 4, 7, 8, and 11 can be referred to. For the sake of brevity, it will not be elaborated here.

In an embodiment, the embodiment of FIG. 13 can be performed independently or in combination. In the absence of conflict, the execution order of each step can be arbitrarily exchanged.

In an embodiment, the AI model-based method may further include: for NW-first training, the UE sends a request to the NW for requesting the AI model information, and the NW responds and sends the AI model information. Alternatively, the base station determines whether to include the AI model information based on the UE capability (general capability and AI capability) reported by NW.

In an embodiment, the AI model-based method may further include: for UE-first training, the base station configures whether the UE needs to report the AI model information.

In an embodiment, the representation of the AI model information may include: an indirect representation of the content of the AI model information, for example, the model naming rule includes the backbone information of the model, and the backbone information can be known by exchanging the AI model name.

In another embodiment, the representation of the AI model information may include: a direct representation of the content of the AI model information, for example, the AI backbone is CNN or Transformer, or the serial number of the AI backbone.

In an embodiment, the content of the model information of the AI model may include: the model information of the AI model used by the encoder and/or the decoder. For example, AI backbone, AI structure or hyper-parameters.

In an embodiment, the UE or network device suggests to use the model information of the AI model, such as AI backbone, AI structure or hyper-parameters.

It should be noted that the steps in the embodiments can be performed separately or in combination. In the absence of conflict, the performing order of each step can be arbitrarily exchanged.

Based on the same inventive concept, the present disclosure also provides a communication apparatus. FIG. 14 is a structural schematic diagram of a communication apparatus in an embodiment of the present disclosure. As shown in FIG. 14, the communication apparatus 1400 includes: the transmission module 1401 and the processing module 1402.

In some possible embodiments, the communication apparatus 1400 may be a first communication device in a communication system, or a chip or system-on-chip in the first communication device, or a functional module, in the first communication device, being used for implementing the methods according to the various described embodiments. The communication apparatus can implement the functions executed by the first communication device according to the various embodiments., and these functions can be implemented through the execution of corresponding software by hardware. The hardware or software includes one or multiple modules corresponding to the described functions.

Accordingly, the transmission module 1401 is used for indicating the model information of the first model to the second communication device. The first model is a trainable model used by the encoder and/or the decoder on the side of the first communication device, or a trainable model suggested by the first communication device to be used by the encoder or the decoder on the side of the second communication device.

In some possible implementations, the processing module 1402 is used for determining the model information of the first model.

In some possible implementations, the model information of the first model includes at least one of the followings: the backbone network of the first model; the network structure of the first model; the hyperparameter of the first model; and the model parameter of the first model.

In some possible implementations, the transmission module 1401 is used for sending the first indication information to the second communication device, where the first indication information is used for indicating the model information of the first model.

In some possible implementations, the transmission module 1401 is used for sending the model information of the first model to the second communication device.

In some possible implementations, before the model information of the first model is indicated to the second communication device, the transmission module 1401 is used for receiving the first message sent by the second communication device, where the first message is used for requesting the model information of the first model from the first communication device.

In some possible implementations, the first communication device is the network device, and the second communication device is the terminal device; the transmission module 1401 is used for receiving the first capability information sent by the second communication device, where the first capability information is at least used for indicating the AI capability of the second communication device. According to the first capability information, the model information of the first model is indicated to the second communication device.

In some possible implementations, the first communication device is the terminal device, and the second communication device is the network device; the transmission module 1401 is used for receiving the training configuration information sent by the second communication device; and the model information of the first model is indicated to the second communication device based on the training configuration information.

In some possible implementations, the communication apparatus 1400 may also be the second communication device in the communication system, or a chip or system-on-chip in the second communication device, or a functional module, in the second communication device, being used for implementing the methods according to the various described embodiments. The communication apparatus can implement the functions executed by the second communication device according to the various described embodiments, and these functions can be implemented through the execution of corresponding software by hardware. The hardware or software includes one or multiple modules corresponding to the described functions.

Accordingly, the transmission module 1401 is used for obtaining the model information of the first model indicated by the first communication device, where the first model is the trainable model used by the encoder and/or the decoder on the side of the first communication device, or the trainable model suggested by the first communication device to be used by the encoder or the decoder on the side of the second communication device; the processing module 1402 is used for training the encoder or the decoder on the side of the second communication device based on the model information of the first model.

In some possible implementations, the model information of the first model includes at least one of the followings: the backbone network of the first model; the network structure of the first model; the hyperparameter of the first model; and the model parameter of the first model.

In some possible implementations, the transmission module 1401 is used for receiving the first indication information sent by the first communication device, where the first indication information is used for indicating the model information of the first model.

In some possible implementations, the transmission module 1401 is used for receiving the model information of the first model sent by the first communication device.

In some possible implementations, the transmission module 1401 is further used for sending the first message to the first communication device, where the first message is used for requesting the model information of the first model from the first communication device; and the model information of the first model indicated, in response to the first message, by the first communication device is obtained.

In some possible implementations, the first communication device is the network device, and the second communication device is the terminal device; the transmission module 1401 is further used for sending the first capability information to the first communication device, where the first capability information is at least used for indicating the AI capability of the second communication device; and the model information of the first model indicated, in response to the first capability information, by the first communication device is obtained.

In some possible implementations, the first communication device is the terminal device, and the second communication device is the network device; the transmission module 1401 is also used for sending the training configuration information to the first communication device; and the model information of the first model indicated, in response to the training configuration information, by the first communication device is obtained.

It should be noted that with respect to the specific implementation processes of the transmission module 1401 and the processing module 1402, the detailed descriptions of the first communication device and the second communication device in the embodiments of FIGS. 4 to 13 can be referred to. For the sake of brevity, it will not be elaborated here.

The transmission module 1401 mentioned in the embodiments of the present disclosure can be a transceiver interface, a transceiver circuit, or a transceiver, and the like; the processing module 1402 can be one or multiple processors.

Based on the same inventive concept, the present disclosure provides a communication device. The communication device can be the network device or the terminal device in one or multiple of the embodiments. FIG. 15 is a structural schematic diagram of a communication device in an embodiment of the present disclosure. Referring to FIG. 15, the communication device 150 adopts general computer hardware, including a processor 151, a memory 152, a bus 153, an input device 154, an output device 155, and an antenna 156.

In some possible implementations, the memory 152 may include computer storage media in the form of volatile and/or non-volatile memory, such as read-only memory and/or random-access memory. The memory 152 may store an operating system, an application, other program modules, an executable code, a program data, a user data, and the like.

The input device 154 can be used for inputting commands and information into the communication device. The input device 154 may be a keyboard or a pointing device, such as a mouse, a trackball, a touchpad, a microphone, a joystick, a gamepad, a satellite TV antenna, a scanner, or similar devices. These input devices can be connected to the processor 151 via the bus 153.

The output device 155 can be used for outputting information from the communication device. Besides a monitor, the output device 155 can also be other peripheral output devices, such as a speaker and/or a printing device. These output devices can also be connected to the processor 151 via the bus 153.

The communication device can be connected to the network via the antenna 156, for example, to a local area network (LAN). In a networked environment, the computer-executable instructions stored in the communication device can be stored in a remote storage device, not limited to local storage.

When the processor 151 in the communication device 150 executes the executable code or application stored in the memory 152, the communication device 150 performs the communication method on the side of the terminal device or the side of the network device as described in the embodiments. The specific performing process can be found in the described embodiments and will not be elaborated here.

In addition, the memory 152 stores computer-executable instructions for implementing the functions of the transmission module 1401 and the processing module 1402 in FIG. 14. The functions/implementation processes of the transmission module 1401 and the processing module 1402 in FIG. 14 can be implemented by the processor 151 in FIG. 15 calling the computer-executable instructions stored in the memory 152. The specific implementation process and functions can be found in the relevant embodiments described herein.

Based on the same inventive concept, the present disclosure provides a terminal device. The terminal device is consistent with the terminal device in one or multiple of the described embodiments. Optionally, the terminal device can be a mobile phone, a computer, a digital broadcast terminal device, a message transceiver device, a game console, a tablet device, a medical device, a fitness device, a personal digital assistant, and the like.

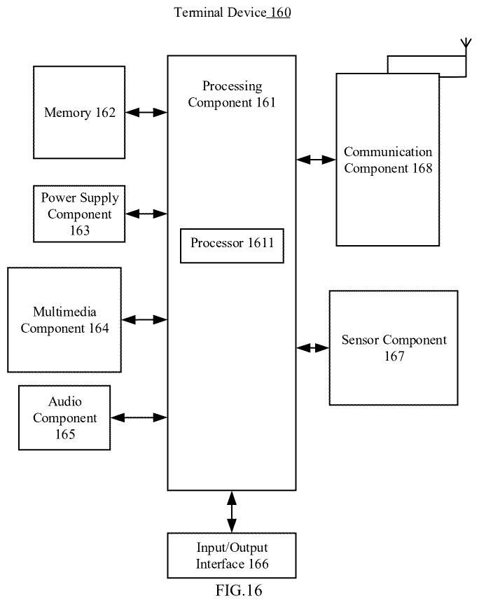

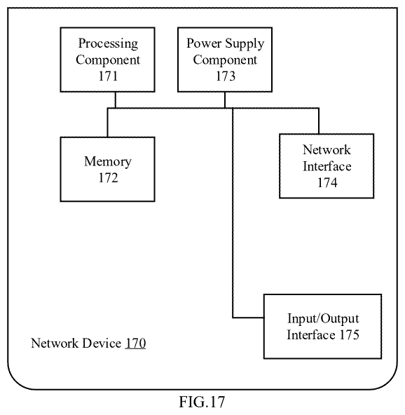

FIG. 16 is a structural schematic diagram of a terminal device in an embodiment of the present disclosure. As shown in FIG. 16, the terminal device 160 may include one or multiple of the following components: a processing component 161, a memory 162, a power supply component 163, a multimedia component 164, an audio component 165, an input/output (I/O) interface 166, a sensor component 167, and a communication component 168.

The processing component 161 usually controls the overall operation of the terminal device 160, such as operations related to display, phone calls, data communication, camera operation, and recording operation. The processing component 161 may include one or multiple processors 1611 to execute instructions to complete all or part of the steps of the methods. In addition, the processing component 161 may include one or multiple modules to facilitate interaction between the processing component 161 and other components. For example, the processing component 161 may include a multimedia module to facilitate interaction between the multimedia component 164 and the processing component 161.

The memory 162 is configured to store various types of data to support the operation of the terminal device 160. Examples of such data include an instruction, a contact data, a phonebook data, a message, a picture, a video, and the like, for any application or method operating on the terminal device 160. The memory 162 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk or an optical disc.

The power supply component 163 provides power to various components of the terminal device 160. The power supply component 163 may include a power management system, one or multiple power supplies, and other components related to generating, managing, and distributing power for the terminal device 160.

The multimedia component 164 includes a screen that provides an output interface between the terminal device 160 and the user. In some embodiments, the screen may include a liquid crystal display (LCD) and a touch panel (TP). If the screen includes a touch panel, the screen can be implemented as a touchscreen to receive input signals from the user. The touch panel includes one or multiple touch sensors to sense touch, swipe, and gestures on the touch panel. The touch sensors can not only sense the boundaries of touch or swipe actions but also detect the duration and pressure related to the touch or swipe operation. In some embodiments, the multimedia component 164 includes a front camera and/or a rear camera. When the terminal device 160 is in the operating mode, such as a shooting mode or a video mode, the front camera and/or rear camera can receive external multimedia data. Each front camera and rear camera can be a fixed optical lens system or have a focal length and an optical zoom capability.

The audio component 165 is configured to output and/or input audio signals. For example, the audio component 165 includes a microphone (MIC), which is configured to receive external audio signals when the terminal device 160 is in an operating mode, such as a call mode, a recording mode, and a voice recognition mode. The received audio signals can be further stored in the memory 162 or sent via the communication component 168. In some embodiments, the audio component 165 also includes a speaker for outputting audio signals.

The I/O interface 166 provides an interface between the processing component 161 and peripheral interface modules, such as a keyboard, a click wheel, buttons, etc. These buttons may include, but are not limited to: a home button, volume buttons, a power button, and a lock button.

The sensor component 167 includes one or multiple sensors for providing various status evaluations for the terminal device 160. For example, the sensor component 167 can detect the on/off state of the terminal device 160, the relative positioning of components, such as the display and keypad of the terminal device 160. The sensor component 167 can also detect the position change of the terminal device 160 or a component of the terminal device 160, the presence or absence of contact between the user and the terminal device 160, the orientation or acceleration/deceleration of the terminal device 160, and the temperature change of the terminal device 160. The sensor component 167 may include a proximity sensor configured to detect the presence of an object nearby without any physical contact. The sensor component 167 may also include a light sensor, such as a CMOS or CCD image sensor, for use in imaging applications. In some embodiments, the sensor component 167 may also include an acceleration sensor, a gyroscope sensor, a magnetic sensor, a pressure sensor, or a temperature sensor.

The communication component 168 is configured to facilitate wired or wireless communication between the terminal device 160 and other devices. The terminal device 160 can access wireless networks using communication standards such as Wi-Fi, 2G, 3G, 4G, or 5G, or a combination thereof. In an exemplary embodiment, the communication component 168 receives broadcast signals or broadcast-related information from an external broadcast management system via a broadcast channel. In an exemplary embodiment, the communication component 168 also includes a near-field communication (NFC) module to facilitate short-range communication. For example, the NFC module may use a radio frequency identification (RFID) technology, an infrared data association (IrDA) technology, an ultra-wideband (UWB) technology, a Bluetooth (BT) technology, and other technologies to facilitate short-range communication.

In an exemplary embodiment, the terminal device 160 can be implemented by one or multiple application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform any of the described methods.

Based on the same inventive concept, the present disclosure provides a network device. The network device is consistent with the network device in one or multiple of the described embodiments.

FIG. 17 is a structural diagram of a network device 170 in an embodiment of the present disclosure. As shown in FIG. 17, the network device 170 may include a processing component 171, which further includes one or multiple processors (not shown), and a memory resource represented by the memory 172, for storing instructions executable by the processing component 171, such as applications. The applications stored in the memory 172 may include one or multiple modules, each corresponding to a set of instructions. Additionally, the processing component 171 is configured to execute instructions to perform any of the described methods applied to the network device.

The network device 170 may also include a power supply component 173 configured to manage the power of the network device 170, a wired or wireless network interface 174 configured to connect the network device 170 to a network, and an input/output (I/O) interface 175. The network device 170 may operate and adopt an operating system stored in the memory 172, such as Windows Server™, Mac OS X™, Unix™, Linux™, FreeBSD™, or similar.

Based on the same inventive concept, the present disclosure also provides a non-transitory computer-readable storage medium. The non-transitory computer-readable storage medium stores instructions. When the instructions are executed on a computer, they are used for implementing the communication method on the side of the first communication device or the side of the second communication device as described in one or multiple embodiments.

Based on the same inventive concept, the present disclosure also provides a computer program or a computer program product. When the computer program product is executed on a computer, the communication method on the side of the first communication device or the side of the second communication device as described in one or multiple of the embodiments is implemented by the computer.

Other implementations of the present disclosure will easily occur to those skilled in the art after considering the description and practicing the invention of the present disclosure. The present disclosure is intended to cover any variations, uses or adaptations of the present disclosure, which follow the general principles of the present disclosure and include common knowledge or common technical means in the art that are not disclosed in the present disclosure. The description and embodiments are to be regarded as exemplary only, with the true scope and spirit of the present disclosure being indicated by the following claims.

It should be understood that the present disclosure is not limited to the precise structure described herein and shown in the drawings, and various modifications and changes can be made without departing from its scope. The scope of the present disclosure is limited only by the appended claims.

1. A communication method, being applied to a first communication device, comprising:
indicating model information of a first model to a second communication device, and
wherein the first model is:
a trainable model used by at least one of an encoder or a decoder on a side of the first communication device, or
a trainable model suggested by the first communication device to be used by an encoder or a decoder on a side of the second communication device.

2. The method according to claim 1, wherein the model information comprises at least one of:
a backbone network of the first model;
a network structure of the first model;
a hyperparameter of the first model; or
a model parameter of the first model.

3. The method according to claim 1, wherein indicating the model information to the second communication device comprises:
sending first indication information to the second communication device, wherein the first indication information is used for indicating the model information.

4. The method according to claim 1, wherein indicating the model information to the second communication device comprises:
sending the model information to the second communication device.

5. The method according to claim 1, further comprising:
receiving a first message sent by the second communication device, wherein the first message is used for requesting the model information from the first communication device.

6. The method according to claim 1, wherein the first communication device is a network device, and the second communication device is a terminal device, and the method further comprises:
receiving first capability information sent by the second communication device, wherein the first capability information is at least used for indicating an artificial intelligence (AI) capability of the second communication device; and
indicating the model information to the second communication device based on the first capability information.

7. The method according to claim 1, wherein the first communication device is a terminal device, and the second communication device is a network device, and the method further comprises:
receiving training configuration information sent by the second communication device; and
indicating the model information to the second communication device based on the training configuration information.

8. A communication method, being applied to a second communication device, comprising:
obtaining model information of a first model indicated by a first communication device,
wherein the first model is:
a trainable model used by at least one of an encoder or a decoder on a side of the first communication device, or
a trainable model suggested by the first communication device to be used by an encoder or a decoder on a side of the second communication device; and
training the encoder or the decoder on the side of the second communication device based on the model information.

9. The method according to claim 8, wherein the model information of the first model comprises at least one of:
a backbone network of the first model;
a network structure of the first model;
a hyperparameter of the first model; or
a model parameter of the first model.

10. The method according to claim 8, wherein obtaining the model information comprises:
receiving first indication information sent by the first communication device, wherein the first indication information is used for indicating the model information.

11. The method according to claim 8, wherein obtaining the model information comprises:
receiving the model information sent by the first communication device.

12. The method according to claim 8, further comprising:
sending a first message to the first communication device, wherein the first message is used for requesting the model information from the first communication device,
wherein obtaining the model information comprises: obtaining the model information indicated, in response to the first message, by the first communication device.

13. The method according to claim 8, wherein the first communication device is a network device, and the second communication device is a terminal device; the method further comprises:
sending first capability information to the first communication device, wherein the first capability information is at least used for indicating an artificial intelligence (AI) capability of the second communication device; and
obtaining the model information indicated, in response to the first capability information, by the first communication device.

14. The method according to claim 8, wherein the first communication device is a terminal device, and the second communication device is a network device; the method further comprises:
sending training configuration information to the first communication device; and
obtaining the model information indicated, in response to the training configuration information, by the first communication device.

15.-28. (canceled)

29. A communication device, comprising:
an antenna;
a memory; and
a processor, respectively connected to the antenna and the memory, and configured to
control transmission and reception of the antenna by executing a computer-executable instruction stored in the memory, and
implement the method according to claim 8.

30. A non-transitory computer-readable storage medium, comprising a computer-executable instruction, and when the computer-executable instruction is executed by a processor, causes the processor to implement the method according to claim 1.

31. A non-transitory computer-readable storage medium, comprising a computer-executable instruction, and when the computer-executable instruction is executed by a processor, causes the processor to implement the method according to claim 8.

32. A communication device, comprising:
an antenna;
a memory; and
a processor, respectively connected to the antenna and the memory, and configured to
control transmission and reception of the antenna by executing a computer-executable instruction stored in the memory, and
indicate model information of a first model to a second communication device, and
wherein the first model is
a trainable model used by at least one of an encoder or a decoder on a side of the communication device, or
a trainable model suggested by the communication device to be used by an encoder or a decoder on a side of the second communication device.

33. The communication device according to claim 32, wherein the model information comprises at least one of followings:
a backbone network of the first model;
a network structure of the first model;
a hyperparameter of the first model; and
a model parameter of the first model.

34. The communication device according to claim 32, wherein the processor is further configured to:
send first indication information to the second communication device, wherein the first indication information is used for indicating the model information; or
send the model information to the second communication device.
